(19) United States
(12) Patent Application Publication
(10) Pub. No.: US 2021/0299829 A1
(43) Pub. Date: Sep. 30, 2021

(54) Torque Structure

(71) Applicant: Wen-Chin Kuo, Taichung City (TW)

(72) Inventor: Wen-Chin Kuo, Taichung City (TW)

(21) Appl. No.: 16/835,506

(22) Filed: Mar. 31, 2020

(51) Int. Cl. B25B 23/14; B25B 23/142; F16D 7/00; F16D 7/08

(52) U.S. Cl. CPC B25B 23/141; B25B 23/1427; B25B 23/0035; F16D 7/08; F16D 7/005

(57) ABSTRACT

A torque structure includes a first driving member, multiple first transmission members, a second driving member, and multiple second transmission members. The first driving member has a first face and multiple first driving recesses. The first transmission members are received in the first driving recesses. The second driving member has a second face and multiple second driving recesses. The second transmission members are received in the second driving recesses. The second transmission members rest on the first transmission members. The first transmission members rest on the second face. The second transmission members rest on the first face. The second transmission members and the first transmission members are arranged between the first driving member and the second driving member, such that the first driving member and the second driving member drive each other.

### BACKGROUND OF THE INVENTION

### 1. Field of the Invention

The present invention relates to a hand tool and, more particularly, to a torque structure.

### 2. Description of the Related Art

A conventional torque structure was disclosed in the U.S. Pat. No. 3,942,337, and comprises an inner cylinder 1, an outer cylinder 2, multiple bearings 7, a first engaging stud 3, and a second engaging stud 4. The first engaging stud 3 is provided with multiple first engaging portions 49. The second engaging stud 4 is provided with multiple second engaging portions 47.

However, such a conventional torque structure has the following disadvantages.

1. The second engaging portions 47 of the second engaging stud 4 mate with the first engaging portions 49 of the first engaging stud 3. The first engaging stud 3 and the second engaging stud 4 have a circular shape, such that the second engaging portions 47 of the second engaging stud 4 and the first engaging portions 49 of the first engaging stud 3 are restricted to have a radiating shape. Thus, the first engaging portions 49 of the first engaging stud 3 and the second engaging portions 47 of the second engaging stud 4 are not worked easily, thereby increasing the cost of the first engaging stud 3 and the second engaging portions 47 of the second engaging stud 4.

2. The bearings 7 are used to function as positioning members. In assembly, the bearings 7 are received between toothed portions of the first engaging portions 49 of the first engaging stud 3 and the second engaging portions 47 of the second engaging stud 4, but the bearings 7 cannot fit the toothed portions, such that the bearings 7 easily fall. In addition, the bearings 7 are not assembled easily.

### BRIEF SUMMARY OF THE INVENTION

In accordance with the present invention, there is provided a torque structure comprising a first driving member, a plurality of first transmission members, a second driving member, and a plurality of second transmission members. The first driving member has a first face, a first end portion, a plurality of first driving recesses, and a first mounting portion. Each of the first transmission members is received in each of the first driving recesses. The second driving member has a second face, a plurality of second driving recesses, and a second mounting portion. Each of the second transmission members is received in each of the second driving recesses. The second transmission members rest on the first transmission members. Each of the first transmission members rests on the second face. Each of the second transmission members rests on the first face. The second transmission members and the first transmission members are arranged between the first driving member and the second driving member, such that the first driving member and the second driving member drive each other.

According to the primary advantage of the present invention, the first driving member is provided with the first driving recesses to receive the first transmission members. The second driving member is provided with the second driving recesses to receive the second transmission members. The first transmission members rest on the second driving member. The first face and the second face have a planar shape, and the first driving recesses and the second driving recesses have a concave shape, such that the first driving member and the second driving member are worked easily to decrease the cost.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partial exploded perspective view of a torque structure in accordance with the first preferred embodiment of the present invention.

FIG. 2 is a perspective assembly view of the torque structure as shown in FIG. 1.

FIG. 3 is a side view of the torque structure as shown in FIG. 2.

FIG. 4 is a cross-sectional view of the torque structure taken along line A-A as shown in FIG. 3.

FIG. 5 is a schematic operational view of the torque structure as shown in FIG. 3.

FIG. 6 is a schematic operational view of the torque structure as shown in FIG. 3.

FIG. 7 is a cross-sectional view of the torque structure taken along line A-A as shown in FIG. 6.

FIG. 8 is a partial exploded perspective view of a torque structure in accordance with the first preferred embodiment of the present invention.

FIG. 9 is a perspective assembly view of the torque structure as shown in FIG. 8.

FIG. 10 is a front view of the torque structure as shown in FIG. 9.

FIG. 11 is a cross-sectional view of the torque structure taken along line B-B as shown in FIG. 10.

FIG. 12 is an exploded perspective view of a torque structure in accordance with the second preferred embodiment of the present invention.

FIG. 13 is a front view of the torque structure as shown in FIG. 12.

FIG. 14 is a cross-sectional view of the torque structure taken along line C-C as shown in FIG. 13.

FIG. 15 is an exploded perspective view of a torque structure in accordance with the third preferred embodiment of the present invention.

FIG. 16 is a front view of a first transmission member of the torque structure as shown in FIG. 15.

FIG. 17 is an exploded perspective view of a torque structure in accordance with the fourth preferred embodiment of the present invention.

FIG. 18 is a cross-sectional assembly view of the torque structure as shown in FIG. 17.

FIG. 19 is a schematic operational view of the torque structure as shown in FIG. 18.

### DETAILED DESCRIPTION OF THE INVENTION

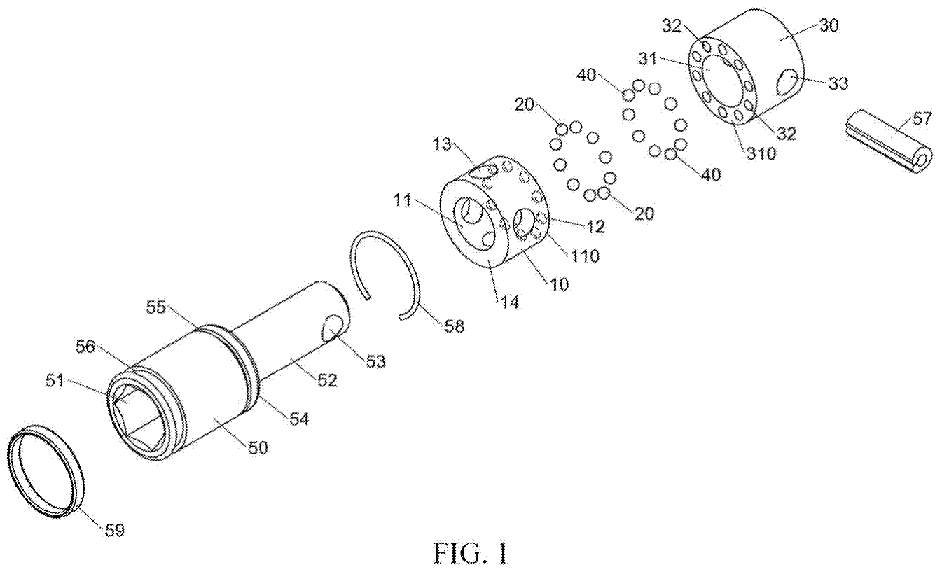

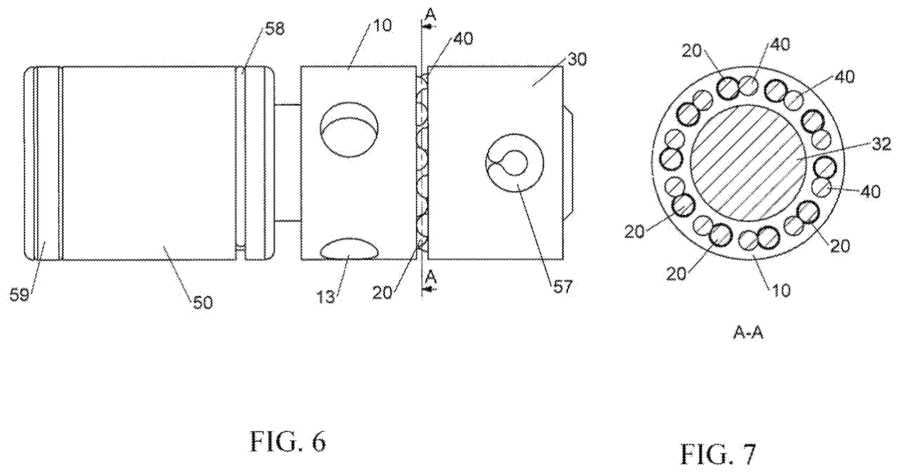

Referring to the drawings and initially to FIGS. 1-7, a torque structure in accordance with the first preferred embodiment of the present invention comprises a first driving member 10, a plurality of first transmission members 20, a second driving member 30, and a plurality of second transmission members 40.

The first driving member 10 has an annular shape and has a first side provided with a first face 110, and a second side provided with a first end portion 14. The first face 110 is provided with a plurality of first driving recesses 12 arranged in an annular manner The first driving member 10 has an axis provided with a first mounting portion 11.

Each of the first transmission members 20 is received in and partially protrudes from each of the first driving recesses 12. The first transmission members 20 have a number equal to that of the first driving recesses 12.

The second driving member 30 aligns with the first driving member 10. The second driving member 30 has an annular shape and has a side provided with a second face 310 aligning with the first face 110. The second face 310 is provided with a plurality of second driving recesses 32 arranged in an annular manner. The second driving recesses 32 have a number equal to that of the first driving recesses 12. Each of the second driving recesses 32 has an opening directed toward an opening of each of the first driving recesses 12. The second driving member 30 has an axis provided with a second mounting portion 31.

Each of the second transmission members 40 is received in and partially protrudes from each of the second driving recesses 32. The second transmission members 40 have a number equal to that of the second driving recesses 32.

The second transmission members 40 rest on the first transmission members 20. Each of the first transmission members 20 rests on the second face 310. Each of the second transmission members 40 rests on the first face 110. The second transmission members 40 and the first transmission members 20 are arranged between the first driving member 10 and the second driving member 30, such that the first driving member 10 and the second driving member 30 are interconnected and drive each other.

In the preferred embodiment of the present invention, the first face 110 has a planar shape. The first mounting portion 11 has a circular shape and penetrates the first driving member 10. Each of the first driving recesses 12 has a concave shape. The first end portion 14 has a planar shape. The second mounting portion 31 aligns with the first mounting portion 11. The second mounting portion 31 has a circular shape and penetrates the second driving member 30. Each of the second driving recesses 32 has a concave shape. A grease is added between each of the first transmission members 20 and each of the first driving recesses 12, to provide a lubricating effect, such that each of the first transmission members 20 is not easily released from each of the first driving recesses 12. A grease is added between each of the second transmission members 40 and each of the second driving recesses 32, to provide a lubricating effect.

In the preferred embodiment of the present invention, the first driving member 10 is provided with a plurality of (preferably four) first receiving holes 13 connected to the first mounting portion 11. The first receiving holes 13 are arranged in an annular manner. Each of the first receiving holes 13 has a circular shape and has an axis perpendicular to that of the first mounting portion 11. The second driving member 30 is provided with a first fitting portion 33 connected to the second mounting portion 31. The first fitting portion 33 has an axis perpendicular to that of the second mounting portion 31. The first fitting portion 33 is a circular perforation penetrating the second driving member 30.

In the preferred embodiment of the present invention, each of the first transmission members 20 has a spherical shape and half protrudes from each of the first driving recesses 12. Each of the first transmission members 20 rolls in each of the first driving recesses 12. Each of the second transmission members 40 has a spherical shape and half protrudes from each of the second driving recesses 32. Each of the second transmission members 40 rolls in each of the second driving recesses 32. Each of the second transmission members 40 has a diameter equal to that of each of the first transmission members 20 and is tangent to each of the first transmission members 20. The second transmission members 40 and the first transmission members 20 have the same number and the same structure. Each of the first transmission members 20 is tangent to the second face 310. Each of the second transmission members 40 is tangent to the first face 110.

In the preferred embodiment of the present invention, the torque structure further comprises an actuating member 50 having a first side provided with a first actuating portion 51, and a second side provided with a connecting section 52. The first actuating portion 51 is a hexagonal recess or a square head. The first mounting portion 11 and the second mounting portion 31 are mounted on the connecting section 52. The first driving member 10 is initially mounted on the connecting section 52, and the second driving member 30 is then mounted on the connecting section 52. The connecting section 52 is a cylinder and is provided with a second fitting portion 53 aligning with the first fitting portion 33. The second fitting portion 53 is a circular perforation penetrating the connecting section 52. The second fitting portion 53 has an axis perpendicular to that of the connecting section 52. The actuating member 50 is provided with a second end portion 54 aligning with and spaced from the first end portion 14. The second end portion 54 is arranged between the first actuating portion 51 and the connecting section 52, and has a planar shape. The first actuating portion 51 has a periphery provided with a first annular groove 55 and a second annular groove 56. The first annular groove 55 is adjacent to the second end portion 54, and the second annular groove 56 is adjacent to an opening of the first actuating portion 51. The second annular groove 56 has width and depth greater than that of the first annular groove 55. The torque structure further comprises a fitting member 57 extending through the first fitting portion 33 and the second fitting portion 53, such that the second driving member 30 is connected with the actuating member 50. The fitting member 57 is a circular elastic pin. The torque structure further comprises a first retainer 58 mounted in the first annular groove 55 and a second retainer 59 mounted in the second annular groove 56. The first retainer 58 is a C-shaped ring. The second retainer 59 is a ring.

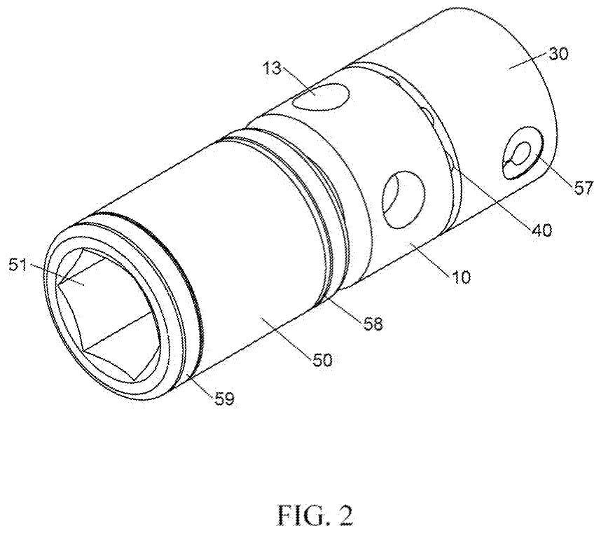

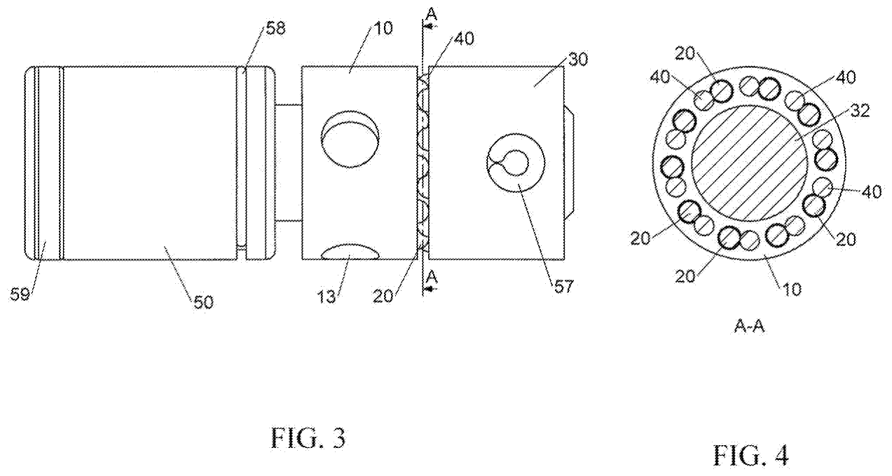

In assembly, the first driving member 10, the first transmission members 20, the second driving member 30, the second transmission members 40, the actuating member 50, the fitting member 57, the first retainer 58, and the second retainer 59 are assembled as shown in FIGS. 2 and 3. Each of the first transmission members 20 is received in each of the first driving recesses 12. The second mounting portion 31 aligns with the first mounting portion 11. Each of the second transmission members 40 is received in each of the second driving recesses 32. The second transmission members 40 rest on the first transmission members 20. The second transmission members 40 and the first transmission members 20 are arranged between the first driving member 10 and the second driving member 30, such that the first driving member 10 and the second driving member 30 are interconnected and drive each other. The first mounting portion 11 and the second mounting portion 31 are mounted on the connecting section 52. The fitting member 57 extends through the first fitting portion 33 and the second fitting portion 53, such that the second driving member 30 is connected with the actuating member 50. The first retainer 58 is mounted in the first annular groove 55, and the second retainer 59 is mounted in the second annular groove 56.

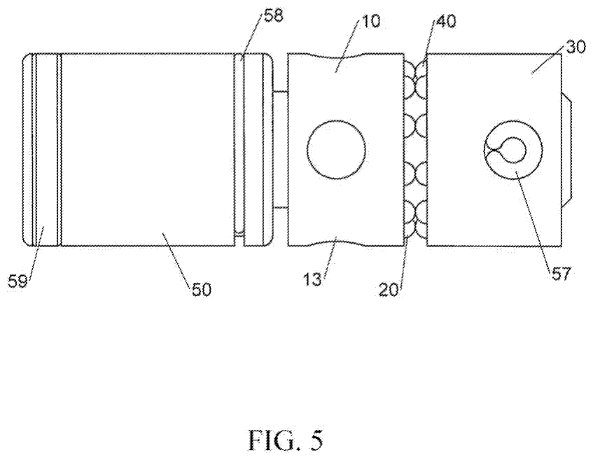

In operation, referring to FIGS. 3-7 with reference to FIGS. 1 and 2, when the first driving member 10 is rotated anticlockwise, each of the first transmission members 20 is moved to abut the right side each of the second transmission members 40 at the right side as shown in FIG. 4, such that the first transmission members 20 drive the second transmission members 40 anticlockwise. In such a manner, the second transmission members 40 drives the second driving member 30 which drives the actuating member 50, such that the actuating member 50 is driven to rotate a workpiece which is fitted onto the first actuating portion 51. When the rotational torque exceeds a predetermined value, the first transmission members 20 are detached from the second transmission members 40, such that the first transmission members 20 align with the second transmission members 40, and the first face 110 and the second face 310 are distant from each other as shown in FIG. 5. At this time, the second driving member 30 drives and moves the actuating member 50, and the second end portion 54 and the first end portion 14 approach each other.

On the contrary, when the first driving member 10 is rotated clockwise, each of the first transmission members 20 is moved to abut the left side of each of the second transmission members 40 as shown in FIG. 7, such that the first transmission members 20 drive the second transmission members 40 clockwise. In such a manner, the second transmission members 40 drives the second driving member 30 which drives the actuating member 50, such that the actuating member 50 is driven to rotate the workpiece.

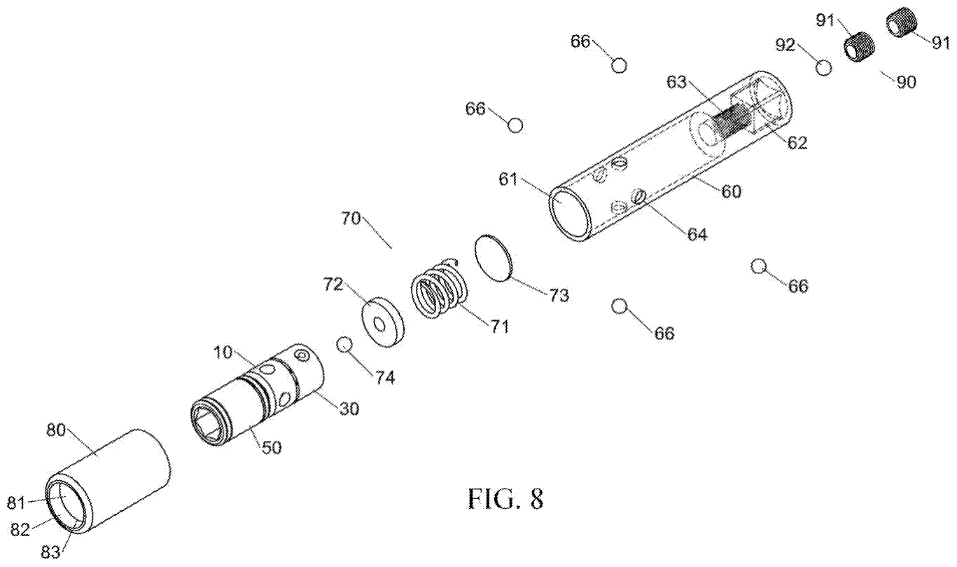

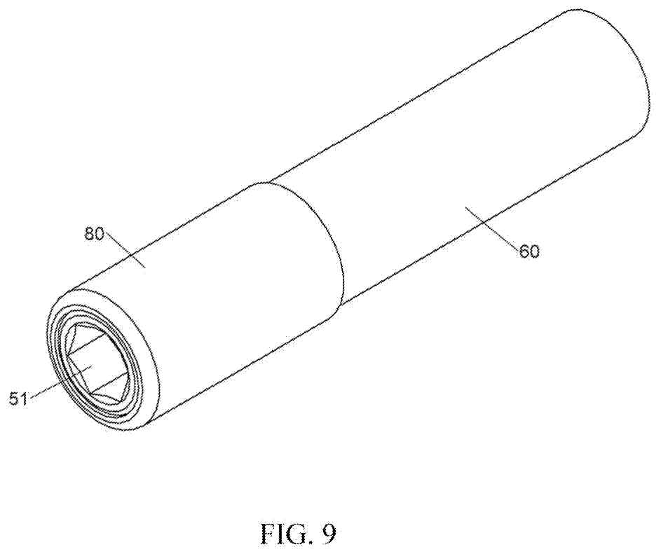

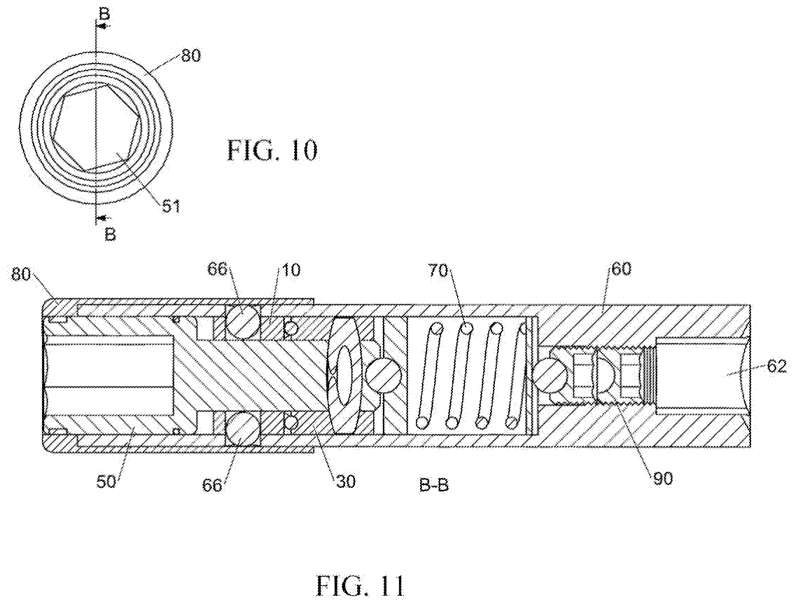

Referring to FIGS. 8-11, the torque structure further comprises a first body 60 having a first side provided with a first receiving chamber 61 and a second side provided with a second actuating portion 62. The first receiving chamber 61 has a circular shape. The first driving member 10, the first transmission members 20, the second driving member 30, the second transmission members 40, the actuating member 50, the fitting member 57, the first retainer 58, and the second retainer 59 are assembled and received in the first receiving chamber 61. The second driving member 30 and the actuating member 50 are movable in the first receiving chamber 61. The opening of the first actuating portion 51 protrudes from the first receiving chamber 61. The first retainer 58 is located between the first annular groove 55 and a wall of the first receiving chamber 61. The second retainer 59 protrudes from the first receiving chamber 61. The second actuating portion 62 is a square recess and is distant from the first actuating portion 51 and an opening of the first receiving chamber 61. A tool is fitted onto the second actuating portion 62 to drive and rotate the first body 60. The first body 60 is provided with a first threaded portion 63 which is an internal thread and is connected between the first receiving chamber 61 and the second actuating portion 62. The first body 60 is provided with a plurality of second receiving holes 64 aligning with the first receiving holes 13. The second receiving holes 64 are arranged in an annular manner and have a number equal to that of the first receiving holes 13. Each of the second receiving holes 64 has a circular shape and is connected to the first receiving chamber 61.

The torque structure further comprises a plurality of restriction members 66 received in the first receiving holes 13 and the second receiving holes 64, such that the first driving member 10 and the first body 60 are connected. Each of the restriction members 66 has a spherical shape. Thus, the second actuating portion 62 drives the first body 60 which drives the first driving member 10 which drives the first transmission members 20 which drive the second transmission members 40 which drives the second driving member 30 which drives the actuating member 50.

The torque structure further comprises an elastic module 70 received in the first receiving chamber 61. The elastic module 70 is initially received in the first receiving chamber 61. Then, the first driving member 10, the first transmission members 20, the second driving member 30, the second transmission members 40, the actuating member 50, the fitting member 57, the first retainer 58, and the second retainer 59 are assembled and received in the first receiving chamber 61. The connecting section 52 abuts the elastic module 70 which elastically presses the connecting section 52. Alternatively, the elastic module 70 elastically presses the second driving member 30.

The torque structure further comprises a second body 80 mounted on the first body 60. The second body 80 has a circular shape and is provided with a second receiving chamber 81 receiving the first body 60. The second receiving chamber 81 has a circular shape. The second body 80 presses the restriction members 66 such that the restriction members 66 are not detached from the first body 60. The restriction members 66 rest on a wall of the second receiving chamber 81. The second body 80 is provided with a third receiving chamber 82 connected to the second receiving chamber 81. The second retainer 59 is located between the second annular groove 56 and the third receiving chamber 82. The third receiving chamber 82 receives the actuating member 50 which is hidden in the first body 60 and the second body 80. The third receiving chamber 82 has a circular shape and has a diameter smaller than that of the second receiving chamber 81. The second body 80 is provided with a first abutting edge 83 which is located between the second receiving chamber 81 and the third receiving chamber 82 and rests on the first body 60.

The torque structure further comprises a screw module 90 screwed into the first threaded portion 63. The screw module 90 is rotated and moved in the first threaded portion 63 to adjust the total length of the elastic module 70 so as to regulate the torque.

In the preferred embodiment of the present invention, the elastic module 70 includes an elastic member 71, a first washer 72, a second washer 73, and a first abutting member 74. The elastic member 71 is a spring structure which is received in the first receiving chamber 61. The elastic member 71 is biased between the first washer 72 and the second washer 73. The first washer 72 is received in the first receiving chamber 61 and rests on a first end of the elastic member 71. The first washer 72 is a circular plate aligning with the connecting section 52. The second washer 73 is received in the first receiving chamber 61 and rests on a second end of the elastic member 71. The second washer 73 is distant from the first washer 72 and aligns with the first threaded portion 63. The first abutting member 74 is received in the first receiving chamber 61 and located between the connecting section 52 and the first washer 72. The first abutting member 74 has a spherical shape. The first washer 72 and the first abutting member 74 are pushed by the elastic member 71 and press the connecting section 52.

The screw module 90 includes a plurality of (preferably two) screw members 91 and a second abutting member 92. The screw members 91 are screwed into the first threaded portion 63. Each of the screw members 91 has an external thread. The second abutting member 92 is received in the first threaded portion 63 and partially extends into the first receiving chamber 61. The second abutting member 92 has a spherical shape and is located between the second washer 73 and the screw members 91. The screw members 91 are rotated and moved in the first threaded portion 63, and drive and move the second abutting member 92 which drives the second washer 73 which presses the elastic member 71, to adjust a compression degree of the elastic member 71, and to achieve a predetermined torque value. The second abutting member 92 is rotated between the second washer 73 and the screw members 91, such that the second abutting member 92 has a rolling friction between the second washer 73 and the screw members 91.

In assembly, the elastic module 70 is initially received in the first receiving chamber 61. Then, the first driving member 10, the first transmission members 20, the second driving member 30, the second transmission members 40, the actuating member 50, the fitting member 57, the first retainer 58, and the second retainer 59 are assembled and received in the first receiving chamber 61. The restriction members 66 are received in the first receiving holes 13 and the second receiving holes 64, such that the first driving member 10 and the first body 60 are connected. The second body 80 is mounted on the first body 60 and the actuating member 50. The second body 80 presses the restriction members 66 such that the restriction members 66 are limited by the second body 80, and will not be detached from the first body 60. The screw module 90 is screwed into the first threaded portion 63, with the second abutting member 92 being located between the second washer 73 and the screw members 91.

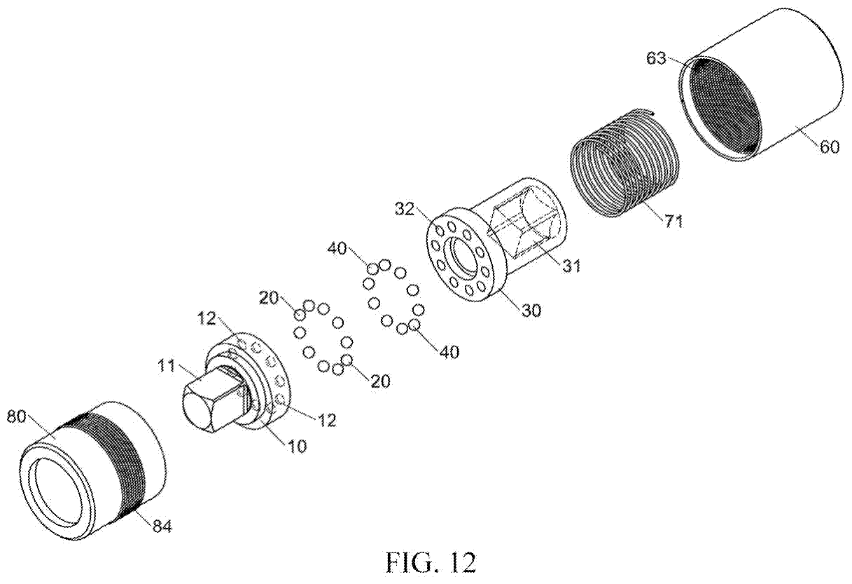

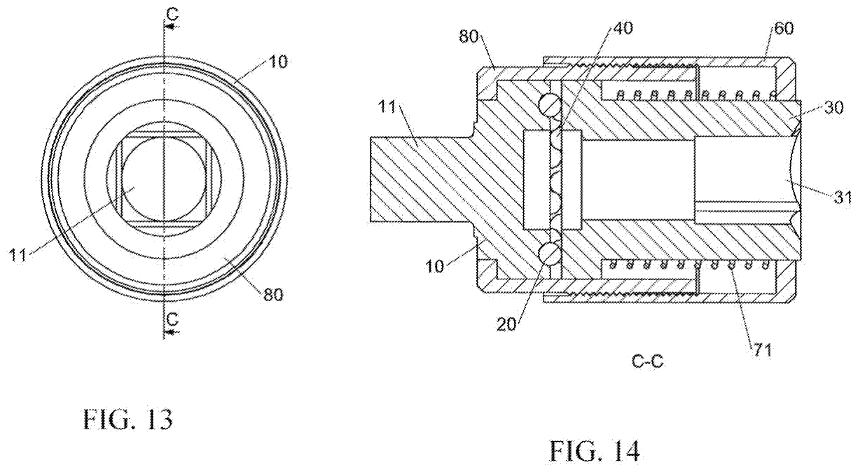

Referring to FIGS. 12-14, in accordance with the second preferred embodiment of the present invention, the first mounting portion 11 is a protruding square head. The first receiving holes 13 are undefined. The second mounting portion 31 is a square recess. A hand tool is mounted on the second mounting portion 31 to drive and rotate the second driving member 30. The second driving member 30 drives and rotates the first driving member 10. The first fitting portion 33 is undefined.

The torque structure further comprises a first body 60 which is a hollow cylinder. The first body 60 is provided with a first receiving chamber 61. The first driving member 10, the first transmission members 20, the second driving member 30, and the second transmission members 40 are assembled and received in the first receiving chamber 61 of the first body 60. The first driving member 10 protrudes from one end of the first body 60. The second mounting portion 31 has an opening protruding from the other end of the first body 60. The first receiving chamber 61 has a periphery provided with a first threaded portion 63.

The torque structure further comprises an elastic member 71 mounted on the second mounting portion 31 and biased between the second driving member 30 and an end portion of the first receiving chamber 61.

The torque structure further comprises a second body 80 which is a hollow cylinder. The second body 80 is mounted on the first driving member 10, and the first body 60 is mounted on the second body 80. The first mounting portion 11 protrudes from the second body 80. A hand tool is mounted on the first mounting portion 11 to be driven by the first driving member 10. The second body 80 has an outer face provided with a second threaded portion 84 which is an external thread screwed onto the first threaded portion 63. The first threaded portion 63 is rotated and moved on the second threaded portion 84, such that the first body 60 is moved and presses the elastic member 71, to adjust a compression degree of the elastic member 71, and to achieve a predetermined torque value.

In operation, when the second mounting portion 31 is driven, the second driving member 30 is rotated to drive the second transmission members 40 which drive the first transmission members 20 which drive the first driving member 10, such that the second driving member 30 drive and rotates the first driving member 10. When the rotational torque exceeds a predetermined value, the second transmission members 40 are detached from the first transmission members 20. At this time, the second driving member 30 is moved in the first body 60 and the second body 80 to compress the elastic member 71.

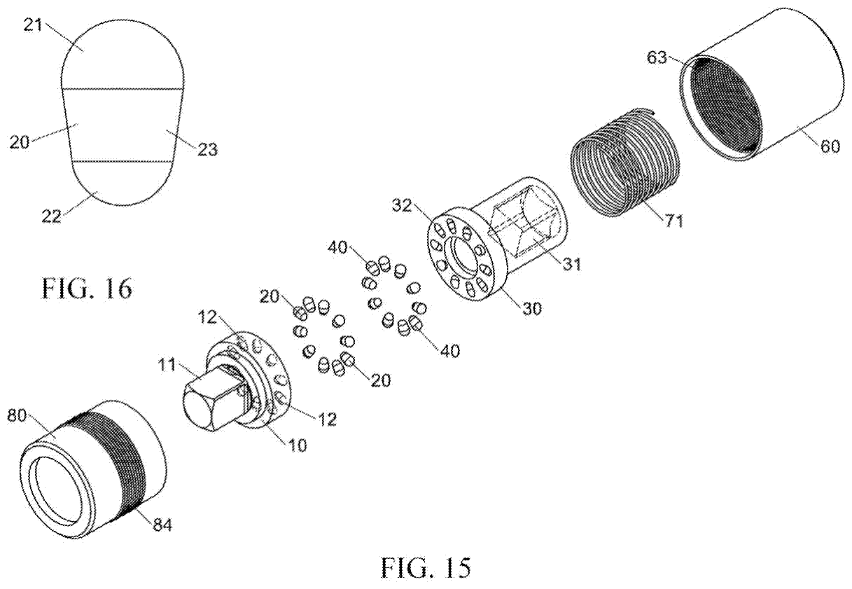

Referring to FIGS. 15 and 16, the structure in accordance with the third preferred embodiment of the present invention is similar to that of the second preferred embodiment, and the difference is described as follows. Each of the first transmission members 20 has a third face 21, a fourth face 22, and two fifth faces 23. The third face 21 is provided on a first side of each of the first transmission members 20 and has a spherical shape. The fourth face 22 is provided on a second side of each of the first transmission members 20 and has a spherical shape. The fourth face 22 is distant from the third face 21 and has a radius smaller than that of the third face 21. The two fifth faces 23 connect the third face 21 and the fourth face 22. The two fifth faces 23 are tangent to the third face 21 and tangent to the fourth face 22. The two fifth faces 23 are inclined from the third face 21 toward the fourth face 22, such that each of the first transmission members 20 has a conical shape. Each of the second transmission members 40 has a structure the same as that of each of the first transmission members 20. Each of the first driving recesses 12 has a structure corresponding to that of each of the first transmission members 20. Each of the second driving recesses 32 has a structure corresponding to that of each of the second transmission members 40.

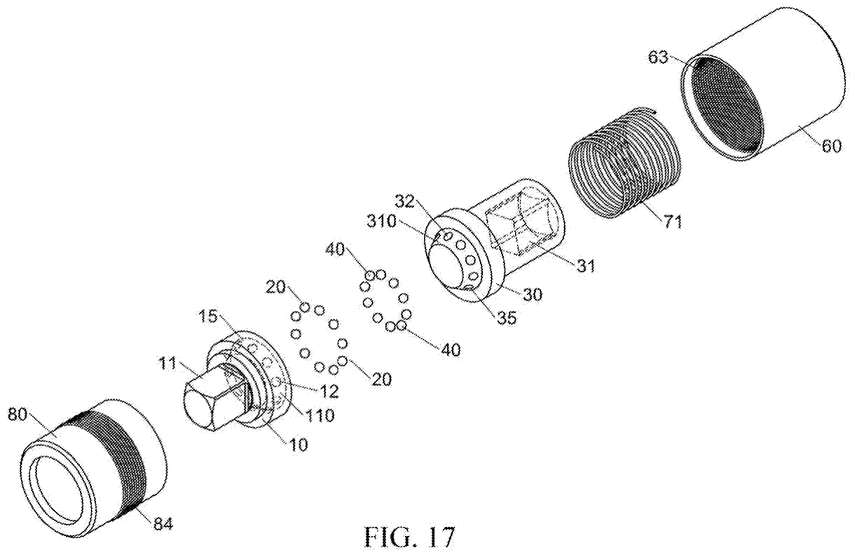

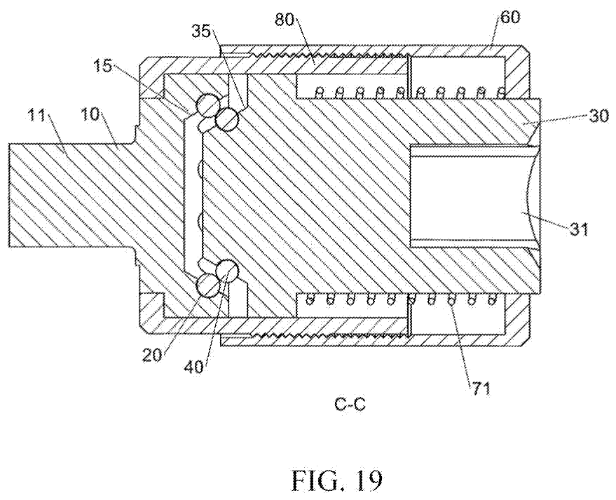

Referring to FIGS. 17-19, the structure in accordance with the fourth preferred embodiment of the present invention is similar to that of the second preferred embodiment, and the difference is described as follows. The first face 110 is provided with a first conical portion 15 which is distant from the first mounting portion 11. The first driving recesses 12 are formed in the first conical portion 15, such that each of the first driving recesses 12 has an oblique shape. The second face 310 is a second conical portion 35 corresponding to the first conical portion 15. The second conical portion 35 is smaller than the first conical portion 15. The second conical portion 35 is distant from the second mounting portion 31. The second driving recesses 32 are formed in the second conical portion 35, such that each of the second driving recesses 32 has an oblique shape.

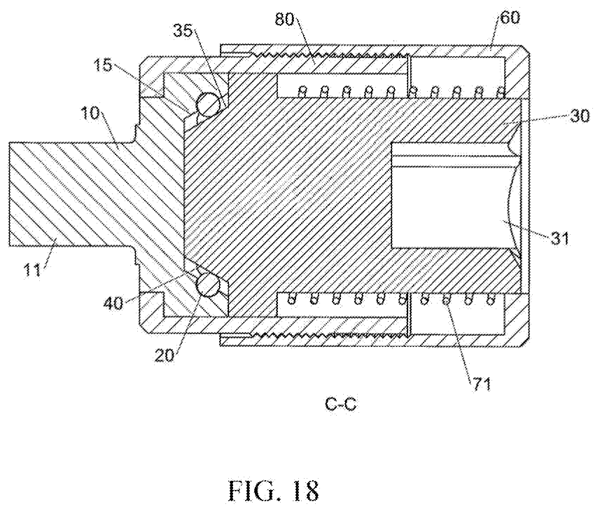

In operation, the first transmission members 20 rest on the second transmission members 40 as shown in FIG. 18. When the second mounting portion 31 is rotated, the second driving member 30 is rotated to drive the second transmission members 40 which drive the first transmission members 20 which drive the first driving member 10 which is rotated to drive a workpiece mounted on the first mounting portion 11. When the rotational torque exceeds a predetermined value, the first transmission members 20 are detached from the second transmission members 40, such that the first transmission members 20 align with the second transmission members 40. At this time, the second driving member 30 is moved in the first body 60 and the second body 80 to compress the elastic member 71.

In conclusion, the first driving member 10, the first transmission members 20, the second driving member 30, and the second transmission members 40 are available for traditional torque structures described in the second preferred embodiment, the third preferred embodiment, and the fourth preferred embodiment.

Accordingly, the torque structure in accordance with the present invention has the following advantages.

1. The first driving member 10 is provided with the first driving recesses 12 to receive the first transmission members 20, the second driving member 30 is provided with the second driving recesses 32 to receive the second transmission members 40, the first transmission members 20 rest on the second driving member 30, the first face 110 and the second face 310 have a planar shape, and the first driving recesses 12 and the second driving recesses 32 have a concave shape, such that the first driving member 10 and the second driving member 30 are worked easily to decrease the cost.

2. The first driving recesses 12 and the second driving recesses 32 have a concave shape, the first transmission members 20 rest on the first face 110, and the second transmission members 40 rest on the second face 310, such that the first transmission members 20 and the second transmission members 40 are received in the first driving recesses 12 and the second driving recesses 32 respectively without detachment, and the torque structure is assembled quickly, to save the cost of time.

3. Each of the first transmission members 20 is a ball that rolls in the first driving recesses 12, such that the first transmission members 20 have a longer lifetime. Each of the second transmission members 40 is a ball that rolls in the second driving recesses 32, such that the second transmission members 40 have a longer lifetime. Thus, the torque structure has a longer lifetime.

4. The first transmission members 20 and the second transmission members 40 are replaced when being worn out, without having to replace the torque structure, thereby saving the cost of replacement.

5. In assembly, the elastic module 70 is initially received in the first receiving chamber 61. Then, the first driving member 10, the first transmission members 20, the second driving member 30, the second transmission members 40, the actuating member 50, the fitting member 57, the first retainer 58, and the second retainer 59 are assembled and received in the first receiving chamber 61, thereby facilitating the assembly of the torque structure.

6. The second body 80 is mounted on the first body 60, and the restriction members 66 are limited by the second body 80, and will not be detached from the first body 60. The second body 80 is closely fitted on the first body 60, such that the second body 80 and the first body 60 have a large contact area. Thus, when the torque structure is dropped and hit, the second body 80 is not detached from the first body 60, such that the restriction members 66 are limited by the second body 80, and are not easily detached from the first body 60.

7. As shown in FIG. 11, the second body 80 is mounted on the first body 60, such that the actuating member 50 is hidden in the first body 60 and the second body 80. The actuating member 50 and the first body 60 have a pivot structure therebetween. The actuating member 50 and the second body 80 also have a pivot structure therebetween. Thus, the first body 60 and the second body 80 have a steady mounting structure therebetween.

8. The first retainer 58 is an elastic element mounted in the first annular groove 55, and the second retainer 59 is an elastic element mounted in the second annular groove 56. A larger tolerance is defined between the outer wall of that the actuating member 50 and the inner wall of the first body 60, thereby decreasing the rotational friction between the actuating member 50 and the first body 60 when the first body 60 is rotated relative to the actuating member 50.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A torque structure comprising:
a first driving member, a plurality of first transmission members, a second driving member, and a plurality of second transmission members;
wherein:
the first driving member has an annular shape and has a first side provided with a first face, and a second side provided with a first end portion;
the first face is provided with a plurality of first driving recesses;
the first driving member has an axis provided with a first mounting portion;
each of the first transmission members is received in and partially protrudes from each of the first driving recesses;
the first transmission members have a number equal to that of the first driving recesses;
the second driving member aligns with the first driving member;
the second driving member has an annular shape and has a side provided with a second face aligning with the first face;
the second face is provided with a plurality of second driving recesses;
the second driving recesses have a number equal to that of the first driving recesses;
the second driving member has an axis provided with a second mounting portion;
each of the second transmission members is received in and partially protrudes from each of the second driving recesses;
the second transmission members have a number equal to that of the second driving recesses;
the second transmission members rest on the first transmission members;
each of the first transmission members rests on the second face;
each of the second transmission members rests on the first face; and
the second transmission members and the first transmission members are arranged between the first driving member and the second driving member, such that the first driving member and the second driving member are interconnected and drive each other.

2. The torque structure as claimed in claim 1, wherein:
the first face has a planar shape;
the first mounting portion has a circular shape and penetrates the first driving member;
each of the first driving recesses has a concave shape;
the first end portion has a planar shape;
the second mounting portion aligns with the first mounting portion;
the second mounting portion has a circular shape and penetrates the second driving member;
each of the second driving recesses has a concave shape; and
grease is added between each of the first transmission members and each of the first driving recesses and added between each of the second transmission members and each of the second driving recesses.

3. The torque structure as claimed in claim 1, wherein:
the first driving member is provided with a plurality of first receiving holes connected to the first mounting portion;
each of the first receiving holes has a circular shape and has an axis perpendicular to that of the first mounting portion;
the second driving member is provided with a first fitting portion connected to the second mounting portion; and
the first fitting portion has an axis perpendicular to that of the second mounting portion.

4. The torque structure as claimed in claim 1, wherein:
each of the first transmission members has a spherical shape and half protrudes from each of the first driving recesses;
each of the first transmission members rolls in each of the first driving recesses;
each of the second transmission members has a spherical shape and half protrudes from each of the second driving recesses;
each of the second transmission members rolls in each of the second driving recesses;
each of the second transmission members has a diameter equal to that of each of the first transmission members and is tangent to each of the first transmission members;
each of the first transmission members is tangent to the second face; and
each of the second transmission members is tangent to the first face.

5. The torque structure as claimed in claim 3, wherein:
the torque structure further comprises an actuating member having a first side provided with a first actuating portion, and a second side provided with a connecting section;
the first mounting portion and the second mounting portion are mounted on the connecting section;
the connecting section is a cylinder and is provided with a second fitting portion aligning with the first fitting portion;
the second fitting portion has an axis perpendicular to that of the connecting section;
the actuating member is provided with a second end portion aligning with and spaced from the first end portion;
the second end portion is arranged between the first actuating portion and the connecting section, and has a planar shape;
the first actuating portion has a periphery provided with a first annular groove and a second annular groove;
the second annular groove has width and depth greater than that of the first annular groove;
the torque structure further comprises:
a fitting member extending through the first fitting portion and the second fitting portion; and
a first retainer mounted in the first annular groove and a second retainer mounted in the second annular groove.

6. The torque structure as claimed in claim 5, wherein:
the torque structure further comprises a first body having a first side provided with a first receiving chamber and a second side provided with a second actuating portion;
the first driving member, the first transmission members, the second driving member, the second transmission members, the actuating member, the fitting member, the first retainer, and the second retainer are assembled and received in the first receiving chamber;
the second driving member and the actuating member are movable in the first receiving chamber;
the first retainer is located between the first annular groove and a wall of the first receiving chamber;
the second retainer protrudes from the first receiving chamber;
the second actuating portion is a square recess;
the first body is provided with a first threaded portion which is an internal thread and is connected between the first receiving chamber and the second actuating portion;
the first body is provided with a plurality of second receiving holes aligning with the first receiving holes;
the second receiving holes have a number equal to that of the first receiving holes;
each of the second receiving holes is connected to the first receiving chamber;
the torque structure further comprises a plurality of restriction members received in the first receiving holes and the second receiving holes;
each of the restriction members has a spherical shape;
the torque structure further comprises an elastic module received in the first receiving chamber;
the connecting section abuts the elastic module which elastically presses the connecting section;
the torque structure further comprises a second body mounted on the first body;
the second body is provided with a second receiving chamber receiving the first body;
the second receiving chamber has a circular shape;
the second body presses the restriction members;
the restriction members rest on a wall of the second receiving chamber;
the second body is provided with a third receiving chamber connected to the second receiving chamber;
the second retainer is located between the second annular groove and the third receiving chamber;
the third receiving chamber receives the actuating member which is hidden in the first body and the second body;
the third receiving chamber has a circular shape and has a diameter smaller than that of the second receiving chamber;
the second body is provided with a first abutting edge which is located between the second receiving chamber and the third receiving chamber and rests on the first body;
the torque structure further comprises a screw module screwed into the first threaded portion; and
the screw module is rotated and moved in the first threaded portion.

7. The torque structure as claimed in claim 6, wherein:
the elastic module includes an elastic member, a first washer, a second washer, and a first abutting member;
the elastic member is received in the first receiving chamber and is biased between the first washer and the second washer;
the first washer is received in the first receiving chamber and rests on a first end of the elastic member;
the first washer aligns with the connecting section;
the second washer is received in the first receiving chamber and rests on a second end of the elastic member;
the second washer aligns with the first threaded portion;
the first abutting member is received in the first receiving chamber and located between the connecting section and the first washer;
the first washer and the first abutting member are pushed by the elastic member and press the connecting section;
the screw module includes a plurality of screw members and a second abutting member;
the screw members are screwed into the first threaded portion;
each of the screw members has an external thread;
the second abutting member is received in the first threaded portion and partially extends into the first receiving chamber;
the second abutting member is located between the second washer and the screw members;
the screw members are rotated and moved in the first threaded portion, and drive and move the second abutting member which drives the second washer which presses the elastic member; and
the second abutting member is rotated between the second washer and the screw members, such that the second abutting member has a rolling friction between the second washer and the screw members.

8. The torque structure as claimed in claim 1, wherein:
the first mounting portion is a protruding square head;
the second mounting portion is a square recess;
the second driving member drives and rotates the first driving member;
the torque structure further comprises a first body which is a hollow cylinder;
the first body is provided with a first receiving chamber;
the first driving member, the first transmission members, the second driving member, and the second transmission members are assembled and received in the first receiving chamber of the first body;
the first driving member protrudes from one end of the first body;
the second mounting portion has an opening protruding from the other end of the first body;
the first receiving chamber has a periphery provided with a first threaded portion;
the torque structure further comprises an elastic member mounted on the second mounting portion and biased between the second driving member and an end portion of the first receiving chamber;
the torque structure further comprises a second body which is a hollow cylinder;
the second body is mounted on the first driving member;
the first body is mounted on the second body;
the first mounting portion protrudes from the second body;
the second body has an outer face provided with a second threaded portion which is an external thread screwed onto the first threaded portion; and
the first threaded portion is rotated and moved on the second threaded portion, such that the first body is moved and presses the elastic member.

9. The torque structure as claimed in claim 1, wherein:
each of the first transmission members has a third face, a fourth face, and two fifth faces;
the third face is provided on a first side of each of the first transmission members and has a spherical shape;
the fourth face is provided on a second side of each of the first transmission members and has a spherical shape;
the fourth face is distant from the third face and has a radius smaller than that of the third face;
the two fifth faces connect the third face and the fourth face;
the two fifth faces are tangent to the third face and tangent to the fourth face;
the two fifth faces are inclined from the third face toward the fourth face, such that each of the first transmission members has a conical shape;
each of the second transmission members has a structure the same as that of each of the first transmission members;
each of the first driving recesses has a structure corresponding to that of each of the first transmission members; and
each of the second driving recesses has a structure corresponding to that of each of the second transmission members.

10. The torque structure as claimed in claim 1, wherein:
the first face is provided with a first conical portion which is distant from the first mounting portion;
the first driving recesses are formed in the first conical portion, such that each of the first driving recesses has an oblique shape;
the second face is a second conical portion corresponding to the first conical portion;
the second conical portion is smaller than the first conical portion;
the second conical portion is distant from the second mounting portion; and
the second driving recesses are formed in the second conical portion, such that each of the second driving recesses has an oblique shape.
